(19) United States
(12) Patent Application Publication
(10) Pub. No.: US 2017/0063292 A1
(43) Pub. Date: Mar. 2, 2017

(54) Solar tracking system for a solar panel

(71) Applicant: MAHINDRA SUSTEN PVT LTD., Mumbai (IN)

(72) Inventors: Basant Kumar Jain, Mumbai (IN); Apurav Padam Jain, Mumbai (IN); Sandeep Jayawant Bhosale, Mumbai (IN)

(21) Appl. No.: 15/244,808

(22) Filed: Aug. 23, 2016

(30) Foreign Application Priority Data
Aug. 24, 2015 (IN) 3218/MUM/2015

(51) Int. Cl. H02S 20/32

(52) U.S. Cl. CPC H02S 20/32

(57) ABSTRACT

The present disclosure envisages a solar tracking system for a solar panel. The solar tracking system comprises a bearing, a torque tube and a linear actuator. The bearing is coupled to the solar panel by means of rails, typically, C-channel, hat section rails. The torque tube is connected to the solar panel, wherein the torque tube is configured to be angularly displaced within the bearing. The linear actuator is coupled to the torque tube, wherein the linear actuator is configured to angularly displace the torque tube, thereby displacing the solar panel. The linear actuator includes a worm and worm gear arrangement of a rack and pinion arrangement. The solar tracking system is powered by either an auxiliary solar panel and/or a battery.

### FIELD

The present disclosure relates to the field of mechanical engineering. Particularly, the present disclosure relates to the field of solar panels.

### BACKGROUND

Solar panels are mounted on vertical posts for trapping sunlight and converting sunlight to energy. Typically this arrangement is in areas where abundant sunlight is available. However, as a result of the movement of the earth, the direction and alignment of the solar panel with respect to the sun varies with respect to the time of the day, and the day of the year, and the latitude and longitude of the place where the solar panel is fixed. The solar panel is required to be angularly displaced during the day to track the apparent movement of the sun. The solar panels are angularly displaced so that the sun's rays are roughly perpendicular to the surface of the solar panel for optimally capturing the maximum solar energy in the panel. This requires the use of a tracking system.

A solar tracker is a device that orients a solar panel, mirrors or lenses toward the sun. Solar trackers are used to minimize the angle of incidence between the incoming sunlight and a photovoltaic panel, thereby increasing the amount of energy produced from a fixed amount of power generating capacity.

Conventionally, complex and expensive tracking systems have been suggested which require elaborate tooling for manufacturing and assemblage and also needs continuous maintenance. Therefore, there is a need for a robust solar tracking system for angularly displacing the solar panel, which should not be complex, should not require too much relative power for operation, must not require any maintenance and should operate 365 days of the year intermittently to track the sun rays incident on the solar panel.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a solar tracking system that is not expensive.

Another object of the present disclosure is to provide a solar tracking system that is not complex.

Still another object of the present disclosure is to provide a solar tracking system that requires less power for operation.

Yet another object of the present disclosure is to provide a solar tracking system that requires less maintenance.

Other objects and advantages of the present disclosure will be more apparent from the following description, which is not intended to limit the scope of the present disclosure.

### SUMMARY

The present disclosure envisages a solar tracking system for a solar panel. The solar tracking system comprises a bearing, a torque tube and a linear actuator. The bearing is coupled to the solar panel. The torque tube is connected to the solar panel, wherein the torque tube is configured to be angularly displaced within the bearing. The linear actuator is coupled to the torque tube, wherein the linear actuator is configured to angularly displace the torque tube, thereby displacing the solar panel.

In an embodiment the bearing is coupled to the solar panel by means of rails, typically, C-channel, hat section rails.

In another embodiment, the solar tracking system is powered by either an auxiliary solar panel and/or a battery.

In an exemplary embodiment, the linear actuator is coupled to the torque tube by a mounting bracket.

In another exemplary embodiment, an arm is coupled to the torque tube by means of fasteners and has a mounting bracket bolted or welded to the free end of the arm.

In an embodiment, the torque tube is connected to the solar panel by means of a U-clamp.

In another embodiment, the bearing is mounted on an operative top end of a vertical post typically C channel, rectangular hollow section.

In still another embodiment, the linear actuator includes a worm and worm gear arrangement.

In yet another embodiment, the linear actuator includes a rack and pinion arrangement.

### BRIEF DESCRIPTION OF ACCOMPANYING DRAWING

A solar tracking system of the present disclosure will now be described with the help of the accompanying drawings, in which:

FIG. 1a illustrates a perspective view of a solar tracking system, in accordance with an embodiment of the present disclosure;

FIG. 1b illustrates an isometric view of a solar tracking system, in accordance with an embodiment of the present disclosure;

FIG. 1c illustrates an isometric view of a solar tracking system, in accordance with an embodiment of the present disclosure;

FIG. 2A illustrates a perspective view of a first position of the solar tracking system of FIG. 1a:

FIG. 2B illustrates a perspective view of a second position of the solar tracking system of FIG. 1a;

FIG. 2C illustrates a perspective view of a third position of the solar tracking system of FIG. 1a; and

FIG. 3 illustrates an isometric view of mounting of a bearing.

### DETAILED DESCRIPTION

A solar tracker is a device that orients a solar panel, mirrors or lenses toward the sun. Solar trackers are used to minimize the angle of incidence between the incoming sunlight and a photovoltaic panel, thereby increasing the amount of energy produced from a fixed amount of power generating capacity.

Conventionally, complex and expensive tracking systems have been suggested which require elaborate tooling for manufacturing and assemblage and also needs continuous maintenance. Therefore, there is a need for a robust solar tracking system for angularly displacing the solar panel, which should not be complex, should not require too much relative power for operation, must not require any maintenance and should operate 365 days of the year intermittently to track the sun rays incident on the solar panel.

The present disclosure envisages a solar tracking system that is designed to overcome the drawbacks of the conventional solar tracking system. A preferred embodiment of the solar tracking system, of the present disclosure will now be described in detail with reference to the accompanying drawing. The preferred embodiment does not limit the scope and ambit of the disclosure. The description provided is purely by way of example and illustration.

In accordance with the present disclosure, the solar tracking system comprises a bearing, a torque tube and a linear actuator. The bearing is coupled to the solar panel. The torque tube is connected to the solar panel, wherein the torque tube is configured to be angularly displaced within the bearing. The linear actuator is coupled to the torque tube, wherein the linear actuator is configured to angularly displace the torque tube, thereby displacing the solar panel.

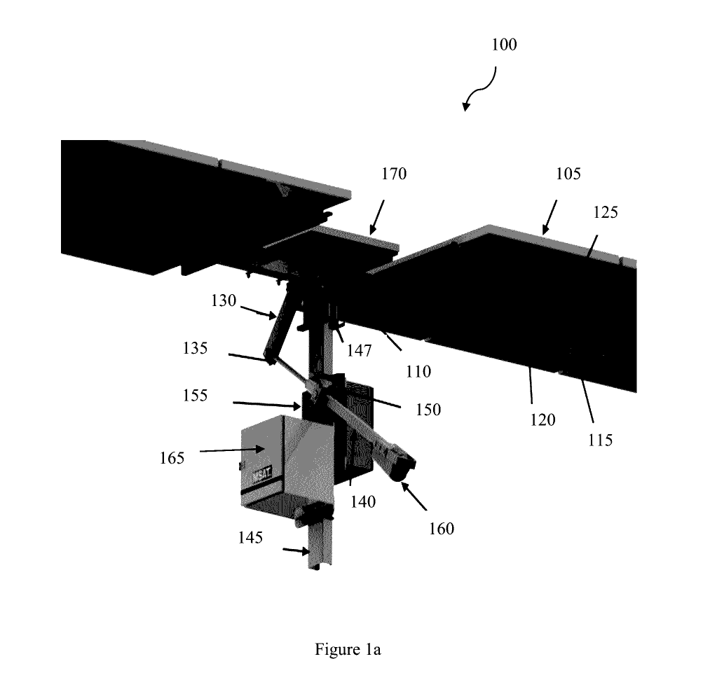

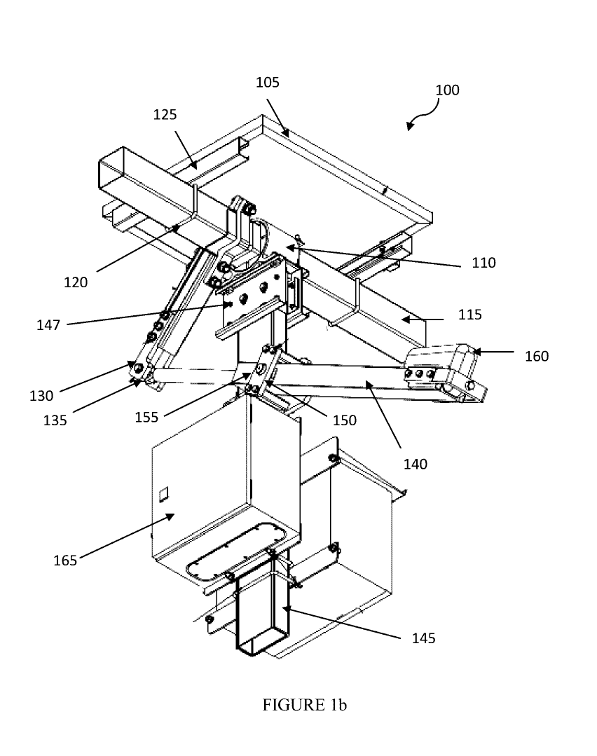

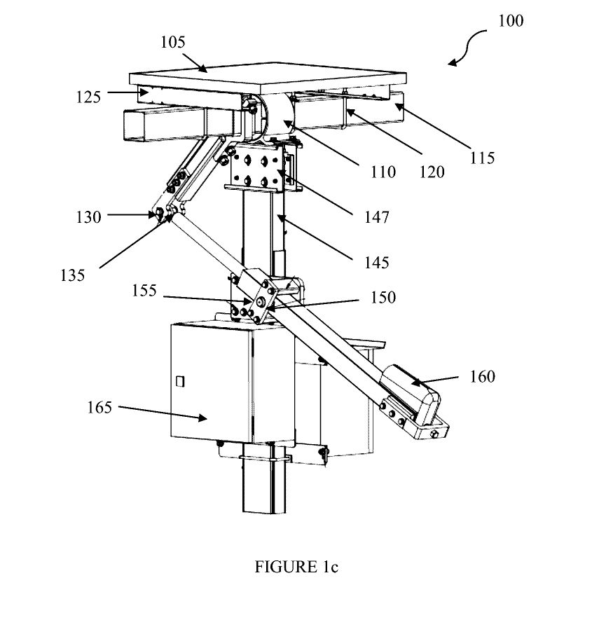

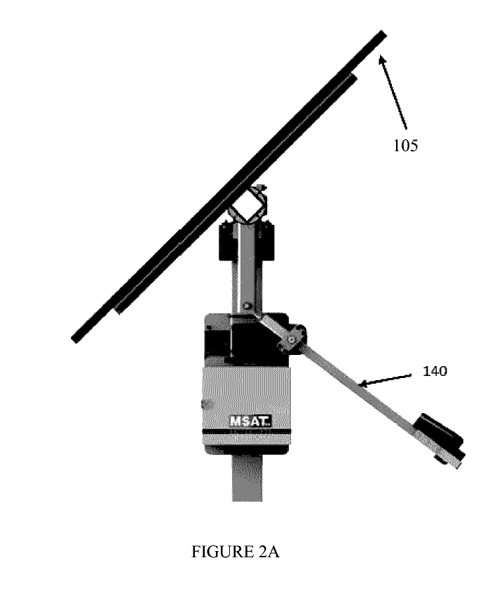

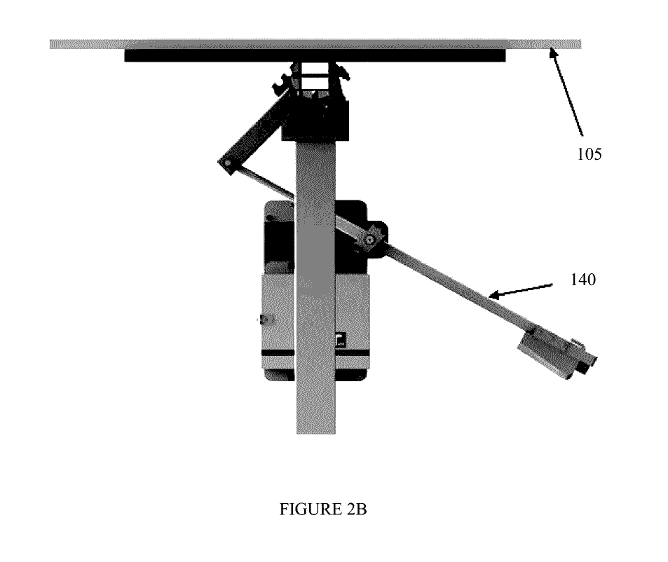

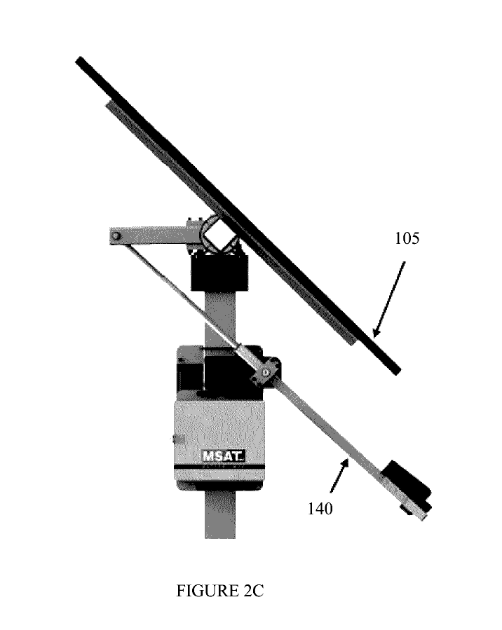

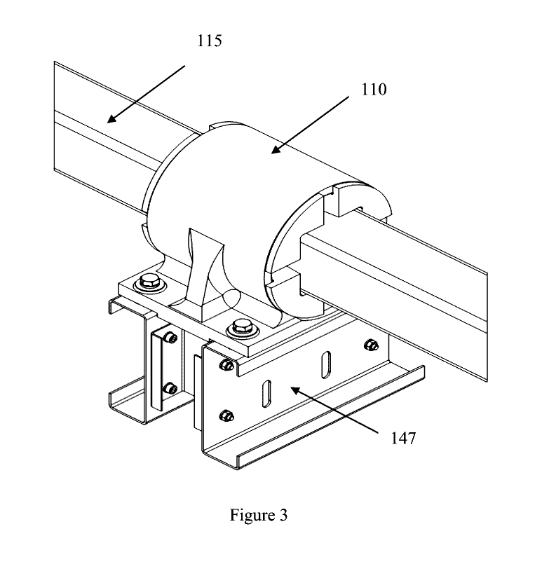

FIG. 1a illustrates a perspective view of a solar tracking system 100 (herein after referred to as the “system”). FIG. 1b and FIG. 1c illustrates an isometric view of the solar tracking system 100. FIG. 2A illustrates a perspective view of a first position of the solar tracking system 100. FIG. 2B illustrates a perspective view of a second position of the solar tracking system 100. FIG. 2C illustrates a perspective view of a third position of the solar tracking system 100. FIG. 3 illustrates an isometric view of mounting of a bearing 110. The solar tracking system 100 for a solar panel 105 includes the bearing 110 coupled to the solar panel 105, a torque tube 115 and a linear actuator 140. The torque tube 115 is connected to the solar panel 105, wherein the torque tube 115 is configured to be angularly displaced within the bearing 110. The linear actuator 140 is coupled to the torque tube 115, wherein the linear actuator 140 is configured to angularly displace the solar panel 105 by means of the torque tube 115.

The bearing 110 is coupled to the solar panel 105 by means of rails. In an embodiment, the rail is a C-channel rails. The solar panel 105 is further connected to the torque tube 115 by a U-clamp 120. In an embodiment, the torque tube 115 is angularly displaced within the bearing 110 through an arc, typically, about 300 degrees.

In an embodiment, an arm 125 extends from the torque tube 115. The arm 125 is coupled to the torque tube 115 by means of fasteners. A mounting bracket 130 is either bolted or welded to the free end of the arm 125. The mounting bracket 130 supports a first pivot pin 135. The distilled end of a linear actuator 140 is connected to the first pivot pin 135, thereby coupling the linear actuator 140 with the mounting bracket 130. In an embodiment, the linear actuator 140 is coupled to the torque tube 115 by means of the mounting bracket 130.

In an embodiment, the bearing 110 is mounted on an operative top end of a vertical post 145. A base 147 is disposed in between the bearing 110 and the vertical post 145, wherein the base 147 is configured to support the bearing 110. In another embodiment, the linear actuator 140 is fitted to the vertical post 145 via a pivot mount 150 and a second pivot pin 155. A motor 160 is fitted to the proximal end of the linear actuator 140. In an embodiment, the linear actuator 140 includes a worm and worm gear arrangement. In another embodiment the linear actuator 140 includes a rack and pinion arrangement.

In still another embodiment, the motor 160 of the linear actuator 140 is connected to an auxiliary solar panel 170. The auxiliary solar panel 170 powers the motor 160 of the linear actuator 140 and therefore, the system 100 under normal operating conditions. The auxiliary solar panel 170 generates between 40 to 320 watts of energy while the motor 160 operates on 24V/0.1 A-10 A power supply. In an embodiment, the motor 160 is a DC motor. In another embodiment, an electronic control device (not shown in the figure) is fitted between the auxiliary solar panel 170 and the motor 160. The electronic control device includes a power source securely placed inside a battery box 165 and a switching assembly which ensures that the motor 160 is driven even if the auxiliary solar panel 170 temporarily stops supplying power because of an obstruction in the sky such as cloud formation. In an embodiment, the power source of the electronic control device is a battery backup. In another embodiment, the electronic control device comprises a controller that may be connected to a central command, which can feed data signals to a receiver for adjusting the movement of the linear actuator 140.

The FIGS. 2A, 2B and 2C show different positions of the linear actuator 140 and the solar panel 105 of the solar tracking system 100 relative to each other. The position of the linear actuator 140 and the solar panel 105 keeps on constantly changing angularly because of the requirement for tracking of the sun during the course of the day from sunrise to sunset. The FIG. 2A depicts a first position of the linear actuator 140 where the surface of the solar panel 105 makes a 90 degree angle approximately with the rays of the sun. The FIGS. 2B and 2C shows the altered position of the linear actuator 140 and the solar panel 105. A second position and a third position of the linear actuator 140 that maintain a 90 degree angle between the surface of the solar panel 105 and the sun rays in accordance with the position of the sun at different times of the day.

The solar tracking system 100 of the present disclosure is driven by the auxiliary solar panel 170 and therefore has minimal requirement of external power source to drive the tracking system. The solar tracking system 100 does not require frequent maintenance and is comparatively less complex than the conventional solar tracking systems.

### Technical Advances and Economical Significance

The present disclosure described herein above has several technical advantages including, but not limited to, the realization of a solar tracking system that:
is not expensive;
is not complex;
requires less power for operation; and
has less maintenance.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A solar tracking system for a solar panel, said system comprising:
a. a bearing coupled to said solar panel;
b. a torque tube connected to said solar panel, wherein said torque tube is configured to be angularly displaced within said bearing; and
c. a linear actuator coupled to said torque tube, wherein said linear actuator is configured to angularly displace said torque tube, thereby displacing said solar panel.

2. The system as claimed in claim 1, wherein said bearing is coupled to said solar panel by means of rails and said torque tube.

3. The system as claimed in claim 1, wherein said system is powered by either an auxiliary solar panel and/or a battery.

4. The system as claimed in claim 1, wherein said linear actuator is coupled to said torque tube by a mounting bracket.

5. The system as claimed in claim 1, wherein an arm is coupled to said torque tube by means of fasteners.

6. The system as claimed in claim 4 and claim 5, wherein said mounting bracket is bolted or welded to a free end of said arm.

7. The system as claimed in claim 1, wherein said torque tube is connected to said solar panel by means of a U-clamp.

8. The system as claimed in claim 1, wherein said bearing is mounted on an operative top end of a vertical post.

9. The system as claimed in claim 1, wherein said linear actuator includes a worm and worm gear arrangement.

10. The system as claimed in claim 1, wherein said linear actuator includes a rack and pinion arrangement.
